(19) United States
(12) Patent Application Publication
(10) Pub. No.: US 2024/0283305 A1
(43) Pub. Date: Aug. 22, 2024

(54) SMALL MOTOR

(71) Applicant: Moving Magnet Technologies, Besançon (FR)

(72) Inventor: Lionel Billet, Dannemarie sur Crète (FR)

(21) Appl. No.: 18/570,207

(22) PCT Filed: Jun. 14, 2022
(86) PCT No.: PCT/FR2022/051146

§ 371 Date: Dec. 14, 2023

(30) Foreign Application Priority Data
Jun. 14, 2021 (FR) FR2106266

(51) Int. Cl. H02K 1/14; H02K 1/2713; H02K 7/116

(52) U.S. Cl. CPC H02K 1/146; H02K 1/2713; H02K 7/116

(57) ABSTRACT

A three-phase electric motor, formed by a stator part excited by three electric windings and a rotor comprising a plurality of magnetized poles, the stator part having radially extending teeth, the stator part comprising: three consecutive wound teeth, each carrying a winding, in a first angular sector, and one to three non-wound complementary teeth, in a second angular sector complementary to the first angular sector.

### CROSS-REFERENCE TO RELATED APPLICATIONS

This application is a national phase entry under 35 U.S.C. § 371 of International Patent Application PCT/FR2022/051146, filed Jun. 14, 2022, designating the United States of America and published as International Patent Publication WO 2022/263769 A1 on Dec. 22, 2022, which claims the benefit under Article 8 of the Patent Cooperation Treaty of French Patent Application Serial No. FR2106266, filed Jun. 14, 2021.

### TECHNICAL FIELD

The present disclosure relates to a three-phase electric motor, of small bulk and of reduced mass, intended especially to drive a multi-stage reduction gear housed in a housing wherein the stator part is integrated so as to allow a good organization of the other components (gear wheels, electronic circuit, etc.).

### BACKGROUND

Patent EP2171831B1 is known in the state of the art, describing a known solution of a three-phase electric motor having a stator part excited by electric windings and by a rotor having N pairs of poles magnetized radially in alternating directions.

The stator part has two angular sectors, alpha-1, and alpha-2, of respective radiuses R1 and R2, with R1 different from R2, comprising wide teeth and narrow teeth, respectively, extending radially from an annular ring. The wide teeth have a width greater than or equal to double the width of the narrow teeth, and the notch width is greater than the width of a narrow tooth. The angular sector alpha-1 is smaller than 220° and comprises at least three windings.

Patent EP3326263 is also known, describing another solution of a geared motor consisting of a housing comprising a brushless motor having at least two electrical phases, a rotor rotating about an axis, and made up of a stator assembly having at least two poles each carrying a winding, the winding axes of which are spaced apart by a mechanical angle of less than 180° and extend radially.

Patent FR3096195 describes another solution of a geared motor comprising a reduction gear train and a three-phase electric motor comprising a stator formed by a stack of laminations and 3*k electric windings and a rotor having k*N pairs of magnetized poles, with k=1 or 2, the stator having two separate angular sectors, alpha 1 and alpha 2, which are centered on the center of rotation of the motor and comprise an alternation of notches and 3*k*N teeth that are regularly spaced and converge toward the center of rotation and define a cavity in which the rotor is arranged, wherein N=4 and in that alpha 1 is less than or equal to 180° and comprises all of the windings of the motor.

The solutions of the background art are satisfactory for applications where there is enough space to house the motor. However, it is not possible to reduce the dimensions homothetically. Indeed, some dimensions are constrained by parameters such as the electrical energy applied to the windings, which do not make it possible to reduce the volume of copper, and therefore the section of the winding wires or the bulk of the windings below a limit. Also, the dimensions of some elements, such as the winding bodies and the electrical connection elements, cannot be reduced in proportion to the size of the motor, and the volume available for the conductive wires of the windings is therefore proportionally reduced. The performance of the motors is, as a consequence, degraded.

The solutions of the background art thereby come up against limits on miniaturization for a fixed power level.

### BRIEF SUMMARY

The subject matter of the present disclosure aims to solve this drawback and relates, according to its most general meaning, to a three-phase electric motor, formed by a stator part excited by three electric windings and a magnetized rotor, the stator part having radially extending teeth, wherein the stator part comprises:
three consecutive wound teeth, each carrying a winding, in a first angular sector,
and one to three non-wound complementary teeth, in a second angular sector complementary to the first angular sector.

In a particular case, the non-wound teeth are configured to adjust to a predetermined reference value the current-free torque of the three wound teeth.

In another particular case, the angular width, the length, and optionally the shape, of the non-wound teeth are adjusted so as to shape the current-free torque curve of the three-phase electric motor, to favor the regularity and smoothness, or a more or less steep indexing of the current-free torque.

Again in another particular case, the angular width, the length and optionally the shape of the non-wound teeth are adjusted so as to balance the radial magnetic forces exerted between the rotor and the teeth of the stator.

Advantageously, the angular spacing between two consecutive wound teeth is 60°.

According to a first embodiment, the stator comprises six teeth, with three non-wound teeth having a spacing of 60°, diametrically opposite the wound tooth.

According to a second embodiment, the stator comprises five teeth, with one non-wound tooth on either side of the first angular sector, with a spacing of 60° between the non-wound tooth and the consecutive wound tooth.

According to a third embodiment, the stator comprises four teeth, with one non-wound tooth diametrically opposite the central wound tooth.

According to one variant, the length of the windings measured radially is less than the diameter of the rotor, to facilitate insertion.

According to another variant, the stator is produced in two parts to allow the insertion of long windings.

According to one variant, the electric motor comprises three non-wound teeth separated by an angle of 60°, each of the non-wound teeth being diametrically opposite to one of the wound teeth.

According to another variant, the electric motor comprises two non-wound teeth located in the second angular sector, the angle formed between each non-wound tooth and the adjacent wound tooth being identical.

According to yet another variant, the electric motor comprises a single non-wound tooth, the non-wound tooth being diametrically opposite the central wound tooth.

In particular, the stator has a cut-out between the non-wound teeth, the space thus freed making it possible to house a magnetically sensitive probe for measuring the position of the rotor.

According to one version, the length of the windings measured radially is less than the diameter of the rotor.

According to another version, the stator is made of two or more parts.

According to yet another version, the rotor has 2^{N} pairs of magnetic poles, N being a natural number smaller than or equal to 2.

Geared motor provided with a housing comprising a three-phase electric motor, as well as a movement transformer.

Geared motor with a housing also comprising control electronics having the means for controlling the three-phase electric motor.

### BRIEF DESCRIPTION OF THE DRAWINGS

The present disclosure will be better understood on reading the following description, which concerns non-limiting exemplary embodiments that are shown by the appended drawings, in which:

FIG. 1 depicts a perspective view of a first exemplary embodiment;

FIG. 2 depicts a front view of a first exemplary embodiment;

FIG. 3 depicts a cross sectional view of a first exemplary embodiment;

FIG. 4 depicts a view of a stator sheet of a first exemplary embodiment;

FIG. 5 depicts a view of a stator sheet of a variant of the first exemplary embodiment having unequal teeth;

FIGS. 6A-6C depict the typical torque curves according to the first optimized exemplary embodiment;

FIG. 7 depicts a perspective view of a third exemplary embodiment;

FIGS. 8A-8C depict the typical torque curves according to the third optimized exemplary embodiment;

FIG. 9 depicts a perspective view of an alternative embodiment of a stator according to the present disclosure;

FIG. 10 depicts a perspective view of different rotor variants according to the present disclosure;

FIG. 11 depicts a perspective view of an alternative embodiment of a stator according to the present disclosure;

FIG. 12 depicts a perspective view of the coupling of the present disclosure to a reduction gear;

FIG. 13 depicts a perspective view of a variant coupling of the present disclosure to a reduction gear;

FIG. 14 depicts a perspective view of a variant coupling of the present disclosure to a reduction gear;

FIG. 15 depicts a perspective view of the variant shown in FIG. 14 and integrated into the housing of a geared motor;

FIG. 16 depicts a perspective view of an alternative embodiment according to the present disclosure provided with a rotor with 2 pairs of poles;

FIG. 17 depicts a perspective view of an alternative embodiment according to the present disclosure provided with a stator having a single non-wound tooth;

FIG. 18 depicts a simulation of the magnetic forces on each of the teeth for two different widths of the non-wound teeth; and

FIG. 19 depicts a simulation of the resultant magnetic forces applied to the stator for two different widths of the non-wound teeth.

### DETAILED DESCRIPTION

The present disclosure therefore aims to propose a motor, intended especially to equip a geared motor, which is economical and robust, suitable for being mass produced, and comprising for this purpose a polyphase electric motor allowing easy integration with a reduction gear or a movement transformer system, respecting all the constraints posed in terms of external dimensions and mass.

For small structures, the space between the teeth is insufficient with the stator architectures of the background art and does not allow enough copper to be housed in the notches. Indeed, the winding bodies have a non-negligible width with respect to the dimension of the motor and, as they cannot be reduced for reasons of moldability and dielectric resistance to be guaranteed between the windings and the stator laminations, it is necessary to increase the space available for the copper. The transition to a smaller number of teeth proposed by the present disclosure makes it possible to increase the available volume of copper. The winding body remaining of constant volume, the ratio of volume of copper to volume of the winding body is therefore favorably impacted. The solution that is the subject matter of the present disclosure consists in choosing a structure of three consecutive wound teeth, to which one to three non-wound teeth are added, i.e., a total of 4 to 6 teeth in combination with a rotor provided at most with 4 pairs of poles, the teeth being distributed at 60° or 120° from one another. Since the winding factor of a structure of 6 teeth with 4 pairs of poles is magnetically unfavorable in comparison to the structures cited above having 12 teeth with 5 pairs of poles, a skilled person will not naturally select it unless the space requirement is sufficiently large.

The motor is supplied with 3 windings only (of a maximum of 6 that it may carry) because this makes it possible to reduce the total volume of the winding body, and therefore maximizes the volume of copper, and greatly simplifies the electrical connections.

The magnetic solution associating a stator that has wound teeth mechanically separated by 60° and a rotor having 4 pairs of poles is not trivial since this configuration has a current-free torque of low-harmonic range and therefore of significant amplitude. The present disclosure proposes to solve this problem by choosing specific angular widths of teeth.

The stator structure is asymmetric, the set of windings being distributed over 3 teeth located in the same angular sector of less than 180°. The complementary angular sector has one, two or three bare teeth, that is to say, without windings, so as to counterbalance the magnetic forces.

Since increasing the length of the non-wound teeth does not have any beneficial incidence on the performance of the machine past a certain length, it is possible to select them to be shorter than the wound teeth, this leading to the ability to inscribe the complementary angular sector, containing the non-wound teeth, in a circular cavity of radius R2 that is shorter than R1, that of the circular cavity inscribing the angular sector containing the wound teeth.

### First Exemplary Embodiment

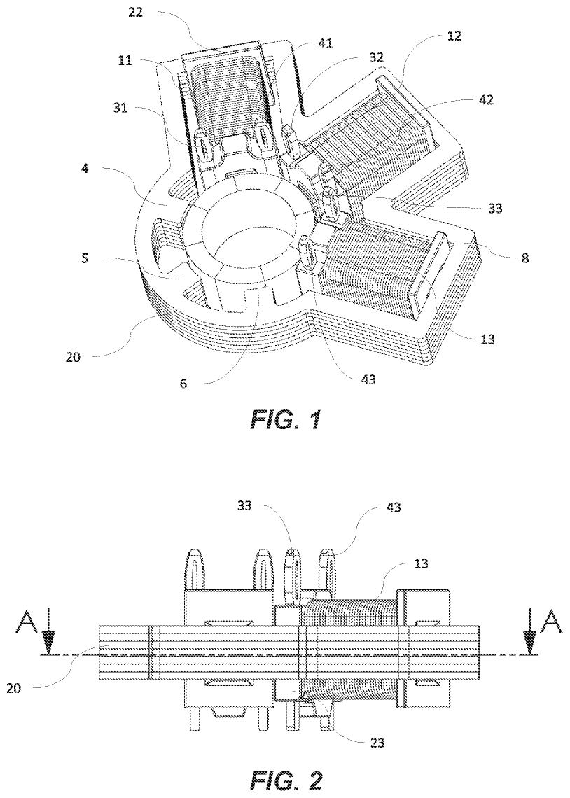

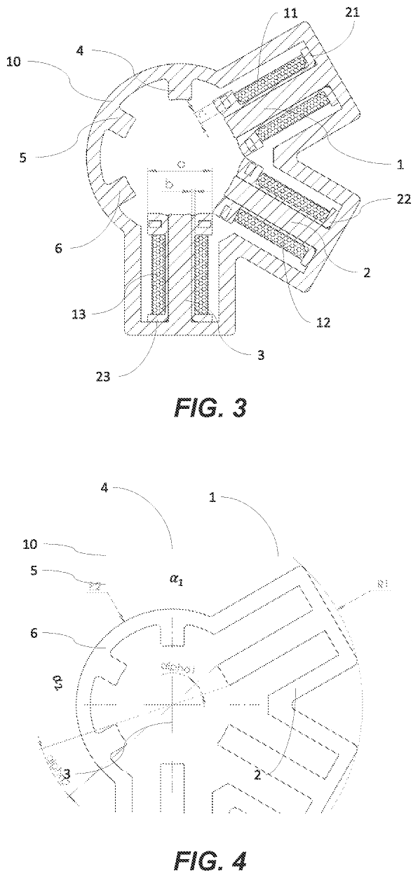

FIGS. 1 to 4 correspond to a first embodiment of a variant with six teeth (1 to 6). Three consecutive teeth (1 to 3) are wound, with windings (11 to 13) respectively supported by an insulating core (21 to 23), forming an angle of 60° therebetween, completed by three shorter, non-wound teeth (4 to 6).

The teeth extend radially with respect to an annular peripheral zone (10).

The stator (30) is formed in a known manner by a stack of laminations (20) cut from a sheet of ferromagnetic metal. The windings (11 to 13) are mounted on a core (21 to 23) having contacts (31 to 33; 41 to 43) of the “press-fit” type allowing connection with a printed circuit.

### Determining the Characteristics of the Non-Wound Teeth

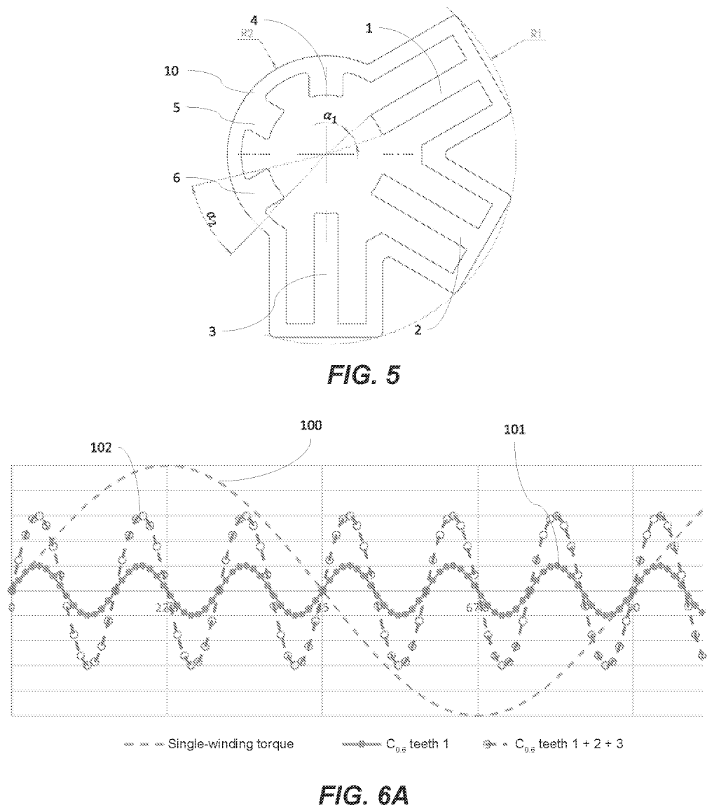

The angular width, a₂, and the length of the non-wound teeth (4 to 6), and optionally their shape, are adjusted as a function of the desired behavior in terms of current-free torque, which may favor the regularity and smoothness, or a more or less steep indexing. These characteristics can be determined empirically, by successive adjustments of a rotor prototype, or by modeling the current-free torque. For a motor having 6 teeth successively separated by a mechanical angle of 60° and in combination with a rotor having 4 pairs of poles, the current-free torque, C₀, can be minimized by choosing teeth having a front end with identical angular spreading, do, with a value between 22° and 23°. However, this configuration with identical teeth is not necessarily optimal because it limits the space that can be allocated to the windings (11, 12, 13). An alternative embodiment according to the present disclosure, presented in FIG. 5, proposes solving this problem by choosing an angular width, a₂, of the non-wound teeth (4 to 6), which is greater than that of the wound teeth (1 to 3), a₁. Good results are obtained when the non-wound teeth (4 to 6) are widened and the wound teeth (1 to 3) are made thinner so as to keep a constant total angular spreading, that is to say, for example, if the wound teeth are made thinner by x°, or a₁=a₀−x, then the non-wound teeth must be widened by an identical value of x°, or a₂=a₀+x. It is thus possible to imagine highly disparate combinations of tooth widths, where x may go up to 5°, leading to non-wound teeth (4 to 6) with a₂=27° associated with wound teeth (1 to 3) with a₁=17°. The mathematical rule for sizing the teeth is not absolute and limiting on the present disclosure, but is only given to illustrate a trend; a skilled person will then be able to obtain perfect compensation by carrying out numerical simulations and empirical adjustments for values close to those taught.

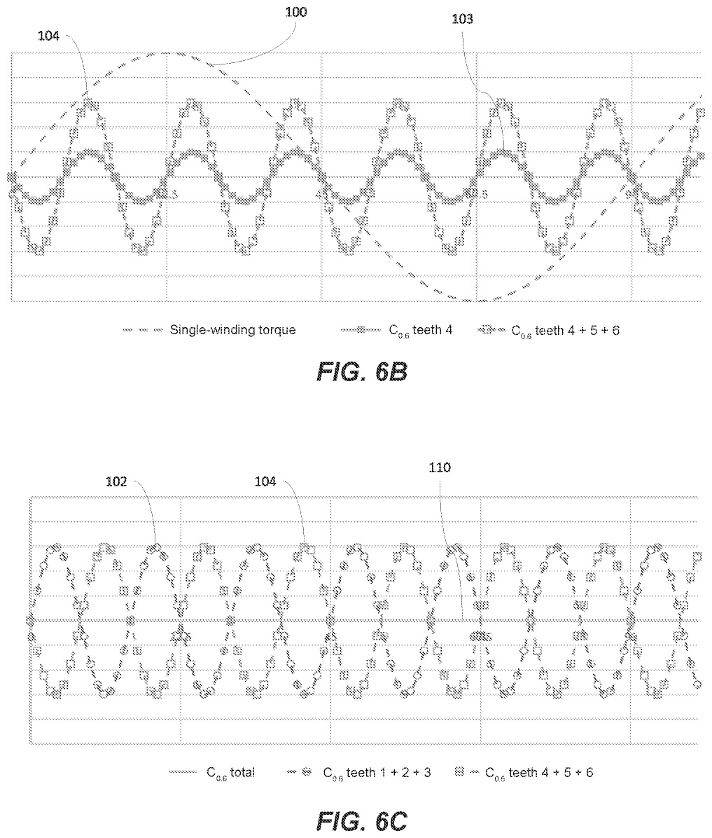

FIGS. 6A-6C depict the torque variations due to the magnetization harmonics 3, perceived by a wound tooth and a non-wound tooth as a function of the mechanical angle and depicted for an electrical period and for a ratio between the angular widths of the wound teeth a₁, and the non-wound teeth a₂ optimized to minimize the current-free torque ripple C₀. FIGS. 6A-6C show the case of a stator with 6 teeth. For a structure with 4 pairs of poles and teeth distributed at mechanical angles that are multiples of 60° (0°, 60°, 120°, 180°, 240°, 300°), the current-free torque ripple, C₀, is C₀ mainly due to the magnetization harmonics 3 and produces a ripple of a frequency 6 times greater than the magnetic period, which is referred to as C_{0.6}. Thus, FIG. 6A shows, in a curve (101), the simulation of the torque C_{0.6} perceived by the wound tooth (1) and the curve (102) depicts the sum of the torques perceived by the set of wound teeth (1 to 3). These pairs have a non-negligible amplitude compared to the torque generated by a winding curve (100), during its supply with the nominal current. An excessive current-free torque will generate undesirable vibrations during operation, leading to premature wear and noise. It is thus very important to limit it as much as possible. FIG. 6B shows, in curve (103), the torque C_{0.6} simulated for the non-wound tooth (4) and the curve (104) shows the sum of the torques C_{0.6} on all the non-wound teeth (4 to 6). It can be noted, as shown in FIG. 6C, that the torques C_{0.6} simulated for the wound teeth curve (102) and for the non-wound teeth curve (104) are of the same amplitude but opposite phase, resulting in perfect cancellation of the torque C_{0.6} summed over all of the teeth (1 to 6) and depicted by the curve (110).

### Second Exemplary Embodiment

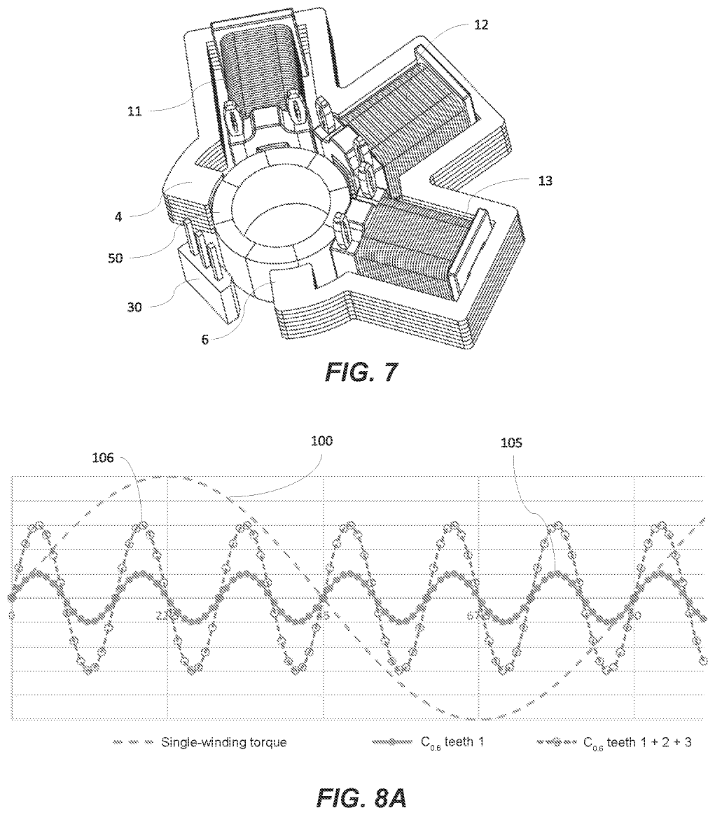

FIG. 7 shows another alternative embodiment with only two non-wound teeth (4 and 6) that are not connected to each other, but connected to the wound teeth (1 and 3), respectively, surrounded by the windings (11, 13). The stator surrounds a magnetized rotor (50). Unconnected teeth is understood to mean that there is an interruption in the magnetic continuity between these teeth at the smallest angle separating them, for example, by means of a cut-out between the teeth of the bundle of laminations constituting the stator. The space freed between the non-wound teeth (4, 6) makes it possible to house a magnetically sensitive probe (30) to measure the position of the rotor and control the electrical supply of the windings.

Contrary to the case with 6 regularly distributed teeth, a structure with 5 teeth distributed at mechanical angles that are multiples of 60° (0°, 60°, 120°, 180°, 240°, 300°), does not have a current-free minimum torque when the teeth have a front end with identical angular spreading. Nevertheless, the present disclosure proposes to solve this problem by choosing an angular width, a₃, of the non-wound teeth (4, 6), which is greater than that of the wound teeth (1 to 3), a₁. Good results are obtained when the angular spreading of the non-wound teeth, a₃, is identical and their total is equal to the total angular spreading of the wound teeth that are also identical, the angular spreading of a wound tooth, a₁, being between 22° and 23°. This leads to the relation 3×1=2×a₃. As explained for the preceding embodiment, this angular spreading a₁ is not necessarily unique or optimal and it can be reduced so as to be able to allocate more spaces to the windings (11, 12, 13). This reduction must be accompanied by an increase in the angular width a₃ of the non-wound teeth so as to keep constant the angular spreading of the teeth (1, 2, 3, 4, 6). For example, if the wound teeth (1, 2, 3) are made thinner by x°, or a₁=a₀−x, then the non-wound teeth (4, 6) must be widened by a complementary value, or

$${α}_{3} = {α}_{0} + \frac{3}{2} x ,$$

so as to satisfy the relation 3×a₁=2×a₃. It is thus possible to imagine highly disparate combinations of tooth widths, where x may go up to 5°, leading to wound teeth (1 to 3) with a₁=17° associated with two non-wound teeth (4, 6) with a₃=40.5°. The mathematical rule for sizing the teeth is not absolute and limiting on the present disclosure, but is only given to illustrate a trend; a skilled person will then be able to obtain perfect compensation by carrying out numerical simulations and empirical adjustments for values close to those taught. A person skilled in the art will also be able to modify the angular spacing between the non-wound teeth and the directly adjacent wound teeth to meet this objective. It may thus differ from 60°, the important aspect being that the angular spacing between one non-wound tooth and the adjacent wound tooth is identical.

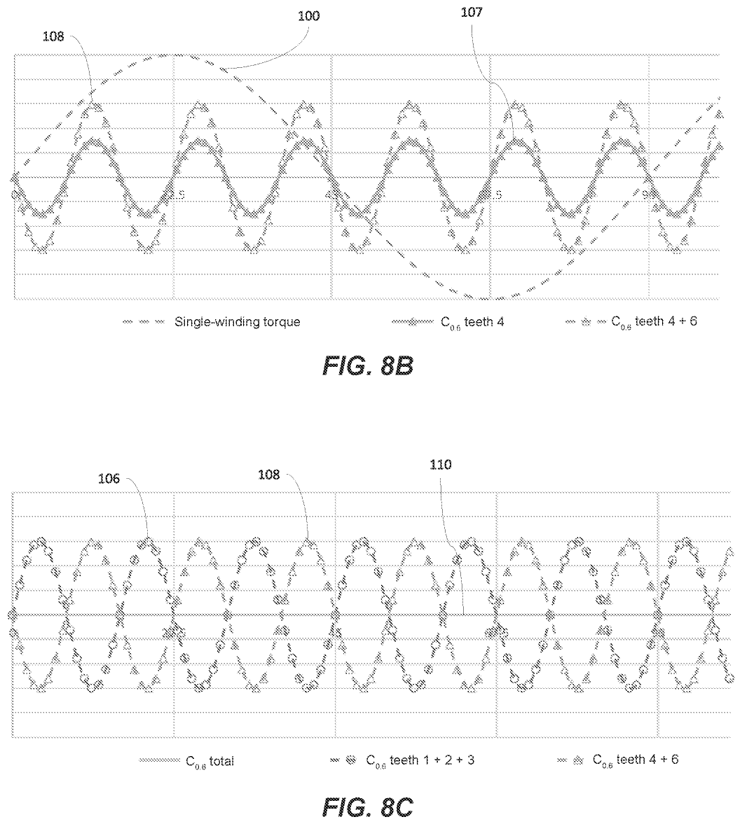

FIGS. 8A-8C depict the torque variations due to the magnetization harmonics 3, perceived by a wound tooth and a non-wound tooth as a function of the mechanical angle and depicted for an electrical period and for a ratio between the angular widths of the wound teeth a₁, and the non-wound teeth a₂ optimized to minimize the current-free torque ripple C₀. FIGS. 8A-8C show the case of a stator with 5 teeth. More particularly, FIG. 8A shows, in curve (105), the simulation of the torque C_{0.6} perceived by the wound tooth (1) and the curve (106) depicts the sum of the torques C_{0.6} perceived by the set of wound teeth (1 to 3). These pairs have a non-negligible amplitude compared to the torque generated by a winding curve (100), during its supply with the nominal current. It is thus very important to limit it as much as possible. FIG. 8B shows in curve (107) the torque C_{0.6} simulated for the non-wound tooth (4) and the curve (108) shows the sum of the torques C_{0.6} on all the non-wound teeth (4, 6). It can be noted, as shown in FIG. 8C, that the torques C_{0.6} simulated for the wound teeth curve (106) and for the non-wound teeth curve (108) are of the same amplitude but opposite phase, resulting in perfect cancellation of the torque C_{0.6} summed over all of the teeth (1 to 6) and depicted by the curve (110).

A final alternative, not shown, is to compensate for the current-free torque using a single non-wound tooth located in the complementary angular sector.

FIGS. 6A-6C as well as FIGS. 8A-8C illustrate the perfect compensation of the current-free torque C_{0.6}, carried out by means of specific tooth widths. Nevertheless, the compensation of the current-free torque is not limiting on the present disclosure, since for certain applications a non-zero amplitude of the current-free torque is desired, for example, to ensure a locking of the actuator when it is not powered. A skilled person will then be able to adjust the width of the wound teeth to optimize the performance of their machine, and then adjust the width of the non-wound teeth to obtain the desired value of the current-free torque.

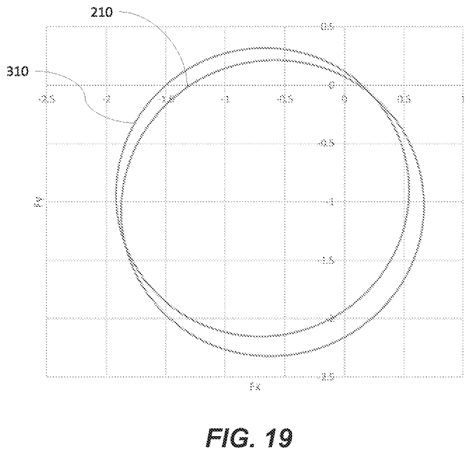

In other cases, when a minimum noise is sought on this asymmetric stator structure, it is decisive to pay attention to the radial forces exerted between the teeth and the rotor and to seek either to balance them as best as possible to avoid a resultant directional force exerted on the rotor, or to minimize the radial forces exerted on the teeth, which lead to vibratory excitations of the stator structure. A person skilled in the art could also adjust the angular width of the wound and non-wound teeth in order to meet this objective. FIGS. 18 and 19 illustrate the magnetic stator forces and compare them for two different tooth widths, either when the non-wound teeth have the same angular width as the wound teeth or when the wound teeth are wider. FIG. 18 depicts a simulation of the magnetic forces in the plane of the laminations (x, y), on each tooth, and for all the rotor positions, when it is driven by the supply of the windings over an electrical period, each ellipsoid corresponding to a tooth. The curves (201, 202, 203) depict the forces on the wound teeth (1, 2, 3) when all the teeth are equal, the curves (204, 205, 206) depict the forces on the non-wound teeth (4, 5, 6) when all the teeth are equal, the curves (301, 302, 303) depict the forces on the wound teeth (1, 2, 3) when the non-wound teeth are angularly wider, and the curves (304, 305, 306) depict the forces on the non-wound teeth (4, 5, 6) when the non-wound teeth are angularly wider. It can be noted that when the non-wound teeth are wider, the ellipsoids have a smaller surface, which corresponds to weaker forces. This is confirmed by FIG. 19, which illustrates the resultant forces applied to the stator for all the teeth of the same angular width (210) or when the wound teeth have a greater angular width (310). It is noted that not only the amplitude of the forces is smaller in the second case, but that they are also more symmetrical, since the ellipsoid is better centered in the plane of the forces.

Finally, the distribution of non-wound teeth, with identical angular spreading, at angles that are multiples of 60° (i.e., 0°, 60°, 120°, 180°, 240°, 300°) once again do not make it possible to optimize the current-free torque C_{0.6} and a person skilled in the art could imagine another distribution, but also different angular widths for the non-wound teeth, for example, to free up space in the complementary angular sector.

### Assembled Stator

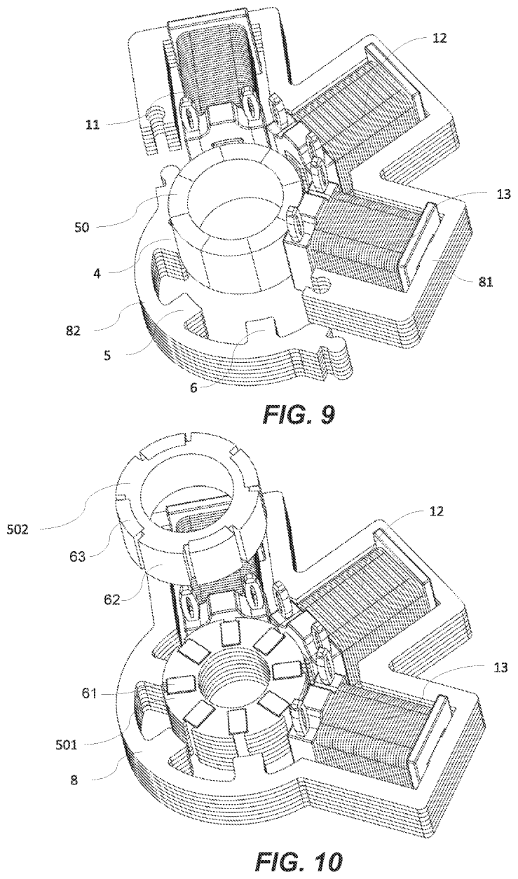

According to an alternative embodiment shown in FIG. 9, the stator (8) can be formed from two parts assembled, for example, by a dovetail, one of the parts (81) comprising the angular sector with the teeth supporting the windings (11, 12, 13), and the other part (82) comprising the complementary angular sector having the non-wound teeth (4, 5, 6). This embodiment makes it possible especially to string long windings (11, 12, 13), the length of which is greater than the diameter of the rotor (50).

### Rotor Variants

The present disclosure is not limited to a ring-type rotor with 4 pairs of poles, as shown in FIG. 1, but can use any rotor variant known to a skilled person. For example, and as shown in FIG. 10, the rotor (501) can have 8 embedded magnets (61), but it is also possible to imagine an alternative that uses fewer magnets, such as the one presented in this same figure with the rotor (502), alternating magnet poles (63) with salient poles (62) made of a soft ferromagnetic material.

Preferentially, the rotor comprises 4 pairs of magnetized poles; however, the present disclosure is not limited to this number, and a smaller number of poles can also be used, while benefiting from the advantages conferred by the present disclosure, by carefully choosing the geometric features of the teeth (4 to 6) without windings. The number of pairs of poles, p, that have the best advantages are obtained according to the formula p=2^{N}, N being a natural number smaller than or equal to 2, that is to say 0, 1 or 2. Thus, FIG. 16 shows a possible variant of a rotor provided with 2 pairs of poles.

Stator Variant with Tooth Snout

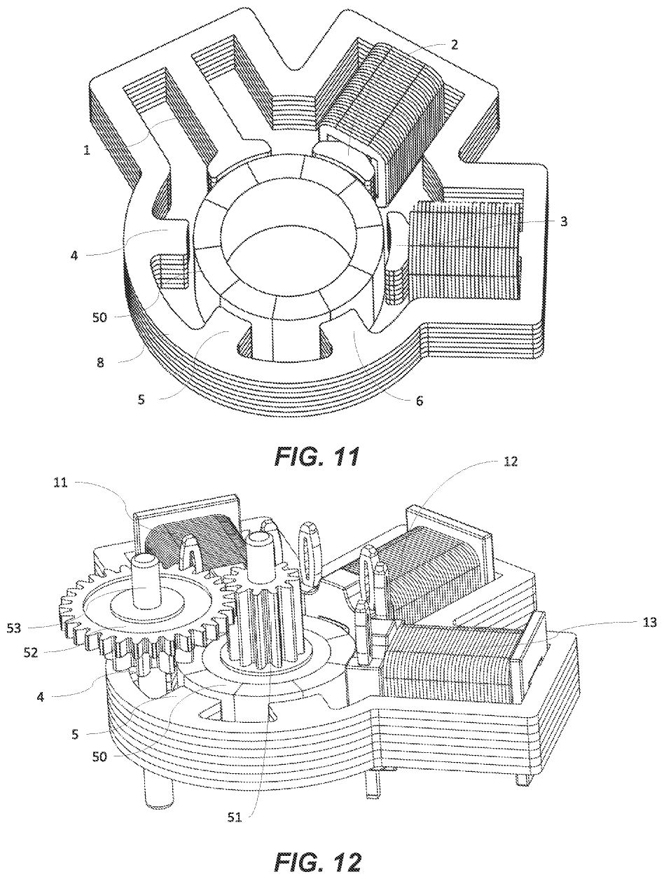

According to one alternative embodiment shown in FIG. 11, the wound teeth (1, 2, 3) can have a front flaring, referred to as tooth snout, making it possible to allocate more space for the windings while optimizing the collection of the rotor flow. It should be noted that the non-wound teeth may also, in addition or alternatively, have tooth snouts so as, for example, to make the teeth thinner in order to make the stator as light as possible.

### Use in a Geared Motor

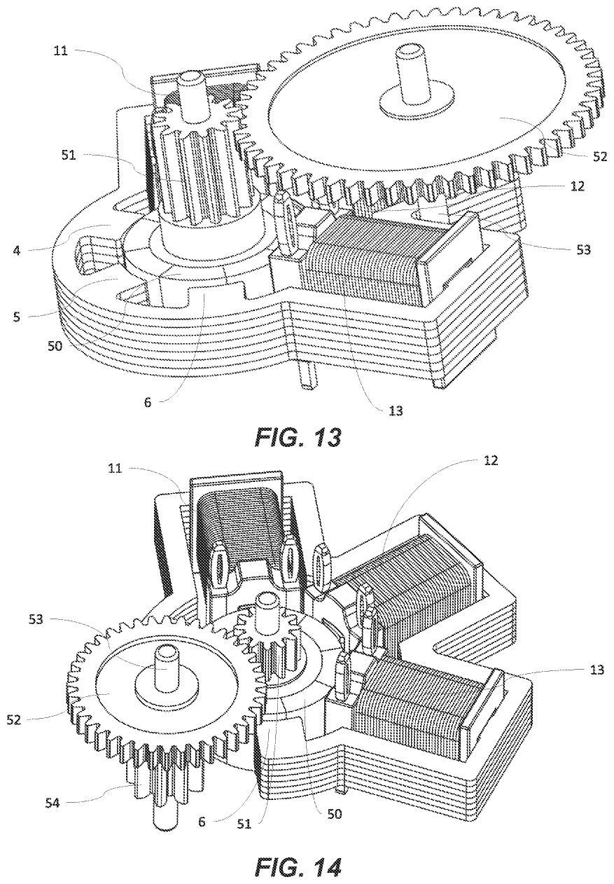

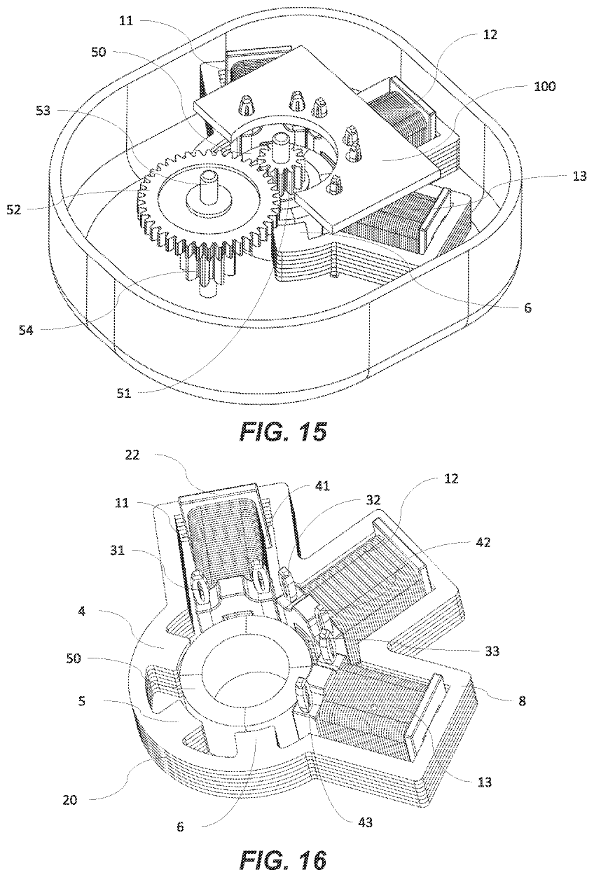

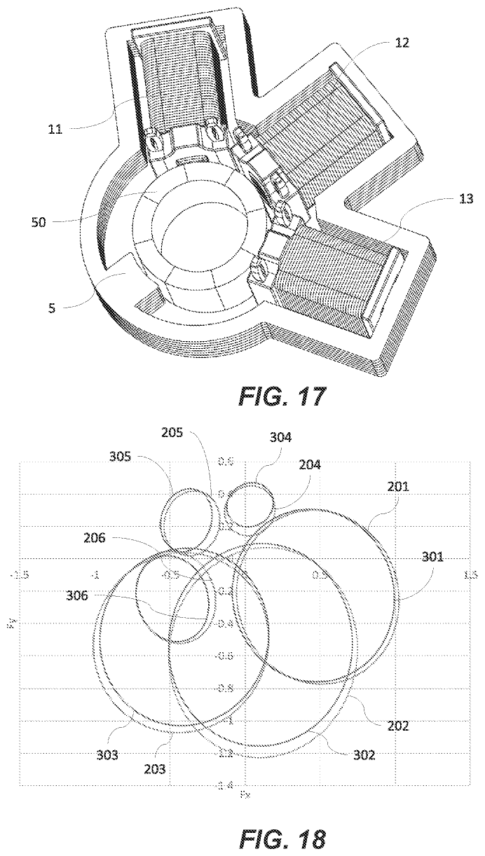

The present disclosure according to all of its variants is of interest for its integration into a geared motor. FIGS. 12, 13 and 14 illustrate different configurations for coupling the rotor with the first module of a reduction gear, and FIG. 15 shows a possible integration into a housing of a geared motor also comprising control electronics having the means for controlling the three-phase motor. The rotor (50) is integral with a pinion (51) that meshes on the gear wheel of a first module (52) for reducing movement. This first module is supported by a shaft (53), of which the arrangement is limited by the bulk of the magnetic circuit. FIG. 12 illustrates the possibility of inserting this shaft between two non-wound teeth (4, 5), which makes it possible to obtain greater latitude for the diameters of the pinion (51) and of the wheel of the module (52) and therefore more choice on the reduction of this first stage. FIG. 13 illustrates another possible positioning of the shaft (53) at the periphery of two windings (12, 13). This configuration makes it possible to completely free the space located in the angular sector not containing a winding and therefore to position the stator in the corner of the housing of a geared motor in order to obtain a very compact solution. Finally, FIG. 14 shows the possibility of inserting the shaft (53) into the free angular sector of one version of the present disclosure with two non-wound teeth, as shown in FIG. 7. Indeed, the two non-wound teeth (4, 6) are not connected by a ferromagnetic circuit and the free space can be used to house the pinion (54) of the first module (52) of the reduction chain. This makes it possible to obtain a version that is highly compact in the axial direction.

1. A three-phase electric motor, comprising:
a stator part excited by three electric windings; and
a rotor comprising a plurality of magnetized poles, the stator part having radially extending teeth, the radially extending teeth including:
three consecutive wound teeth, each carrying a winding, in a first angular sector; and
one to three non-wound complementary teeth, in a second angular sector complementary to the first angular sector.

2. The three-phase electric motor of claim 1, wherein an angular width and a length of the non-wound teeth are configured so as to shape a current-free torque curve of the three-phase electric motor, to favor the regularity and smoothness, or a more or less steep indexing of the current-free torque.

3. The three-phase electric motor of claim 1, wherein the angular width and the length of the non-wound teeth are configured so as to balance radial magnetic forces exerted between the rotor and the teeth of the stator.

4. The three-phase electric motor of claim 1, wherein the angular spacing between two consecutive wound teeth is 60°.

5. The three-phase electric motor of claim 2, wherein the one to three non-wound complementary teeth include three non-wound teeth separated by an angle of 60°, each of the non-wound teeth being diametrically opposite to one of the wound teeth.

6. The three-phase electric motor of claim 1, wherein the one to three non-wound complementary teeth include two non-wound teeth located in the second angular sector, an angle defined between each non-wound tooth and the adjacent wound tooth being identical.

7. The three-phase electric motor of claim 6, wherein the stator has a cut-out between the non-wound teeth, a space within the cut-out is configured to house a magnetically sensitive probe for measuring the position of the rotor.

8. The three-phase electric motor of claim 1, wherein the one to three non-wound complementary teeth comprises a single non-wound tooth, the single non-wound tooth being diametrically opposite to a central wound tooth of the three consecutive wound teeth.

9. The three-phase electric motor of claim 1, wherein a length of the windings measured radially is less than a diameter of the rotor.

10. The three-phase electric motor of claim 1, wherein the stator is made of two or more parts.

11. A geared motor provided with a housing comprising a three-phase electric motor according to claim 1, and a movement transformer.

12. The geared motor according to claim 11, wherein the housing also comprises control electronics configured to control the three-phase electric motor.

13. The three-phase electric motor of claim 1, wherein the rotor has 2^{N} pairs of magnetic poles, N being a natural number smaller than or equal to 2.

14. The three-phase electric motor of claim 2, wherein a shape of the non-wound teeth are configured so as to shape a current-free torque curve of the three-phase electric motor, to favor the regularity and smoothness, or a more or less steep indexing of the current-free torque.

15. The three-phase electric motor of claim 3, wherein a shape of the non-wound teeth is configured so as to balance radial magnetic forces exerted between the rotor and the teeth of the stator.
